(19) United States
(12) Patent Application Publication
(10) Pub. No.: US 2025/0259553 A1
(43) Pub. Date: Aug. 14, 2025

(54) SYSTEM AND METHOD FOR ATMOSPHERIC AIR DENSITY ANOMALY SENSING USING REFRACTION

(71) Applicant: Rockwell Collins, Inc., Cedar Rapids, IA (US)

(72) Inventor: James P Mitchell, Cedar Rapids, IA (US)

(21) Appl. No.: 18/439,027

(22) Filed: Feb. 12, 2024

(51) Int. Cl. G08G 5/00; G01S 7/00; G01S 13/95; G01W 1/00; G01W 1/02

(52) U.S. Cl. CPC G08G 5/34; G01S 7/003; G01S 13/951; G01S 13/955; G01W 1/02; G01W 2001/003

(57) ABSTRACT

A systema and method for atmospheric anomaly detection is disclosed. The method may include performing a time synching between a network of ground-based nodes and a plurality of satellites of a constellation. The method may include directing a transmission of signals between the network and the plurality of satellites, where the signals are configured to be aimed along a plurality of paths through an atmospheric space between the network and the satellites. The method may also include receiving and aggregating signal data corresponding to the signals via at least one of the network or the satellites, determining signal characteristics based on the signal data, identifying one or more atmospheric anomalies based on the signal characteristics, and adjusting a flight plan based on the one or more atmospheric anomalies.

### TECHNICAL FIELD

The present disclosure relates generally to atmospheric anomalies and, more particularly, to a system and method for sensing atmospheric air density anomalies using refraction.

### BACKGROUND

Atmospheric anomalies, such as clear air turbulence (CAT) dangers, can have significant impacts on various industries, including aviation. For example, air density anomalies can cause turbulence, which can be dangerous for aircraft. CAT may be clear and undetectable visually, making CAT turbulence difficult to avoid.

Current methods for detecting atmospheric anomalies may rely on self-reported data. For example, pilots may report to ATC when they experience CAT so that future flight paths may avoid those areas/altitudes. This may be slow and/or ineffective in avoiding all CAT. Furthermore, these methods may not be able to provide real-time data, which can be critical for certain applications.

Therefore, there may be a need for a system and method for detecting atmospheric anomalies with improved accuracy, resolution, and real-time capabilities.

### SUMMARY

A method for atmospheric anomaly detection is disclosed in accordance with one or more illustrative embodiments of the present disclosure. In one illustrative embodiment, the method may include performing a time synching between a network of ground-based nodes and a plurality of satellites of a constellation. In another illustrative embodiment, the method may include directing a transmission of signals between the network and the plurality of satellites, where the signals are configured to be aimed along a plurality of paths through an atmospheric space between the network and the satellites. In another illustrative embodiment, the method may include receiving and aggregating signal data corresponding to the signals via at least one of the network or the satellites. In another illustrative embodiment, the method may include determining signal characteristics based on the signal data, where the signal characteristics may include at least one of times of arrival, dispersion, phase velocity, group velocity, or power level differentials. In another illustrative embodiment, the method may include identifying one or more atmospheric anomalies based on the signal characteristics. In another illustrative embodiment, the method may include adjusting a flight plan based on the one or more atmospheric anomalies.

In a further aspect, the plurality of satellites may include at least two separated antenna elements spanning a distance, where a portion of the signal data corresponding to a common signal is configured to be received via the at least two separated antenna elements and corresponding to at least two spatially distinct refracted beams of the common signal, and where the signal characteristics include the distance. In another aspect, the distance may be based on an evaluation of a spatial configuration of the at least two antenna elements arrayed on one or more antenna sub-systems of a singular satellite. Alternatively, the distance may be based on an evaluation of a spatial configuration between separate satellites. In another aspect, the signal characteristics may include scintillation determined based on the distance.

In another aspect, the one or more atmospheric anomalies may include a size and a depth. In another aspect, the method may further include aggregating the one or more atmospheric anomalies to extract and generate four-dimensional (4D) atmospheric anomaly data. In another aspect, the signals may span multiple radio frequency (RF) bands. In another aspect, the method may further include identifying regions and associated atmospheric densities of the regions based on the signal characteristics, and adjusting the flight plan to fly through a particular region based on a respective atmospheric density of the region being higher than an alternative atmospheric density of an alternative region. In another aspect, the adjusting of the flight plan may be configured to be communicated via a communication interface positioned in an electromagnetically transparent nose radome of the aircraft, where the communication interface includes at least one of an optical communication interface or an RF communication interface.

A system for atmospheric anomaly detection is disclosed in accordance with one or more illustrative embodiments of the present disclosure. In one illustrative embodiment, the system may include a network of ground-based nodes. In another illustrative embodiment, the system may include a plurality of satellites of a constellation. In another illustrative embodiment, the network and the plurality of satellites may be configured to perform time synching. In another illustrative embodiment, the system may include one or more controllers with processors configured to execute program instructions for performing time synching between the network and the satellites, directing signal transmissions, receiving and aggregating signal data, determining signal characteristics, identifying atmospheric anomalies, and adjusting a flight plan based on the anomalies.

In a further aspect, the plurality of satellites may include at least two separated antenna elements spanning a distance, with signal data corresponding to a common signal received via the separated antenna elements and corresponding to spatially distinct refracted beams of the common signal. In another illustrative embodiment, the distance may be based on an evaluation of a spatial configuration of the antenna elements arrayed on one or more antenna sub-systems of a singular satellite. In another illustrative embodiment, the distance may be based on an evaluation of a spatial configuration between separate satellites. In another illustrative embodiment, the signal characteristics may include scintillation determined based on the distance. In another illustrative embodiment, the atmospheric anomalies may include a size and a depth. In another illustrative embodiment, the program instructions may be further configured to cause the processors to aggregate the atmospheric anomalies to extract and generate four-dimensional atmospheric anomaly data. In another illustrative embodiment, the signals may span multiple radio frequency bands.

In another illustrative embodiment, the program instructions may be further configured to cause the processors to identify regions and associated atmospheric densities of the regions based on the signal characteristics, and the adjustment of the flight plan may include flying through a particular region based on a respective atmospheric density of the region being higher than an alternative atmospheric density of an alternative region. In another illustrative embodiment, the adjustment of the flight plan may be communicated via a communication interface positioned in an electromagnetically transparent nose radome of the aircraft, where the communication interface may include an optical communication interface or an RF communication interface.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A illustrates a simplified block diagram of an aircraft, in accordance with one or more embodiments of the present disclosure.

FIG. 1B illustrates an aircraft including displays for displaying atmospheric anomalies, in accordance with one or more embodiments of the present disclosure.

FIG. 2A is a system including a network of ground-based nodes and a constellation of satellites, in accordance with one or more embodiments of the present disclosure.

FIG. 2B is a set of refracted beams dispersed across one or more satellites, in accordance with one or more embodiments of the present disclosure.

FIG. 3 is a flow diagram illustrating steps performed in a method for atmospheric anomaly detection, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly speaking, embodiments of the concepts disclosed herein are directed to a system and method for atmospheric anomaly detection using refraction. In particular, the system and method may utilize a network of ground-based nodes and a constellation of satellites to detect and identify atmospheric anomalies, such as clear air turbulence (CAT). The system and method may involve transmitting signals between the network and the satellites, receiving and aggregating signal data, determining signal characteristics, identifying atmospheric anomalies, and adjusting flight plans based on the identified anomalies. The system and method may provide real-time data and may be used to improve flight planning and safety.

Phase velocity, group velocity, and power level differentials are key characteristics of signal propagation in various media, particularly in the context of wave physics and telecommunications.

Phase velocity is the rate at which the phase of a wave propagates in a medium. It is the speed at which a particular phase (for example, the crest) of the wave appears to travel.

Group velocity, on the other hand, is the velocity with which the overall envelope shape of the wave's amplitudes—known as the modulation or envelope of the wave—propagates. It can be thought of as the signal velocity of the waveform.

Scintillation may refer to a change (e.g., rapid change) in the amplitude, phase, frequency, and/or polarization of a signal as it passes through a medium. In the context of ground-to-satellite transmissions (or vice versa), scintillation may be caused by air turbulence, leading to irregularities in the refractive index of the atmosphere. This air turbulence can create “pockets” of air varying in temperature and pressure, causing the signal to refract or change direction and speed, leading to fluctuations in the received signal.

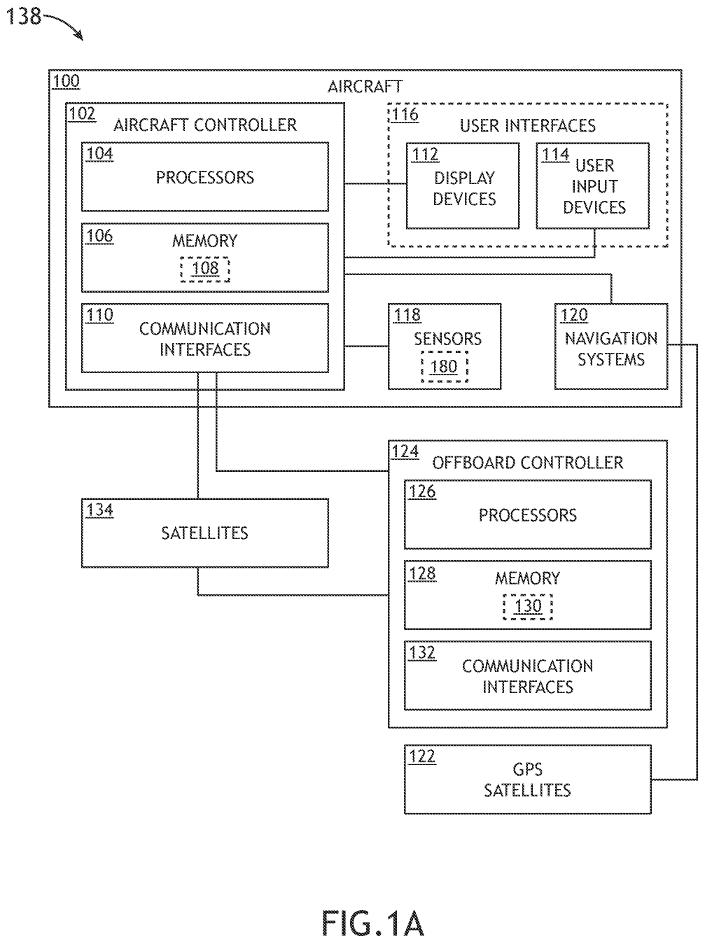

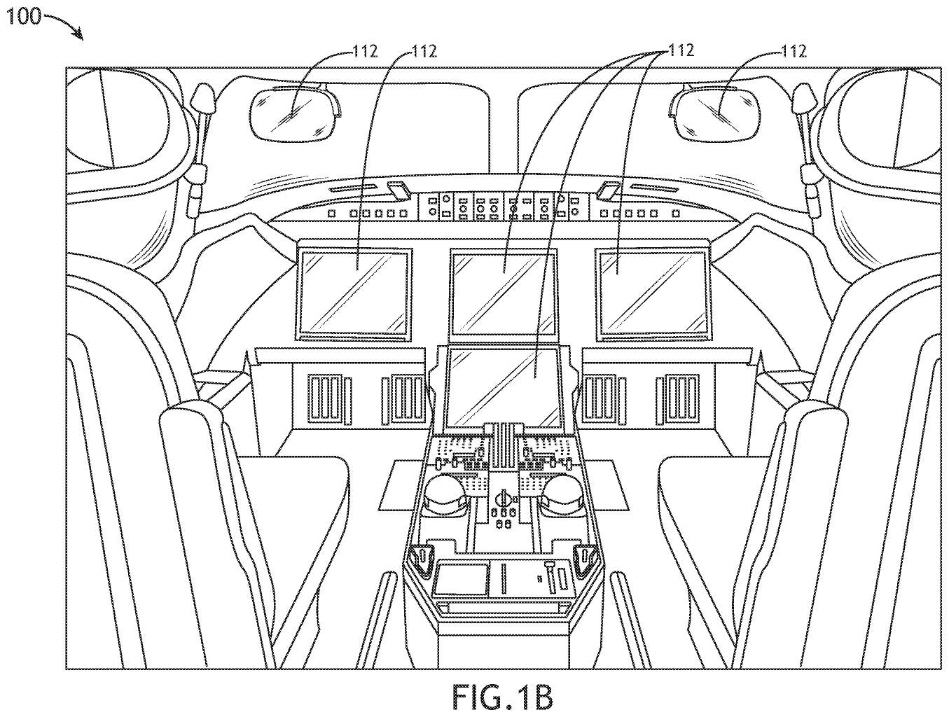

FIGS. 1A-1B illustrate an aircraft including a system for atmospheric anomaly detection, in accordance with one or more embodiments of the present disclosure.

Referring now to FIG. 1A, the aircraft 100 may include an aircraft controller 102 (e.g., on-board/run-time controller). The aircraft controller 102 may include one or more processors 104, memory 106 configured to store one or more program instructions 108, and/or one or more communication interfaces 110.

The aircraft 100 may include an avionics environment such as, but not limited to, a cockpit. The aircraft controller 102 may be coupled (e.g., physically, electrically, and/or communicatively) to one or more display devices 112. The one or more display devices 112 may be configured to display three-dimensional images and/or two-dimensional images. Referring now to FIG. 1B, the avionics environment (e.g., the cockpit) may include any number of display devices 112 (e.g., one, two, three, or more displays) such as, but not limited to, one or more head-down displays (HDDs) 112, one or more head-up displays (HUDs) 112, one or more multi-function displays (MFDs), one or more adaptive flight displays (AFDs) 112, one or more primary flight displays (PFDs) 112, or the like. The one or more display devices 112 may be employed to present flight data including, but not limited to, situational awareness data (e.g., atmospheric anomalies) and/or flight queue data to a pilot or other crew member. For example, the situational awareness data (e.g., atmospheric anomalies) may be based on, but is not limited to, aircraft performance parameters, aircraft performance parameter predictions, sensor readings, alerts, or the like.

Referring again to FIG. 1A, the aircraft controller 102 may be coupled (e.g., physically, electrically, and/or communicatively) to one or more user input devices 114. The one or more display devices 112 may be coupled to the one or more user input devices 114. For example, the one or more display devices 112 may be coupled to the one or more user input devices 114 by a transmission medium that may include wireline and/or wireless portions. The one or more display devices 112 may include and/or be configured to interact with one or more user input devices 114.

The one or more display devices 112 and the one or more user input devices 114 may be standalone components within the aircraft 100. It is noted herein, however, that the one or more display devices 112 and the one or more user input devices 114 may be integrated within one or more common user interfaces 116.

Where the one or more display devices 112 and the one or more user input devices 114 are housed within the one or more common user interfaces 116, the aircraft controller 102, one or more offboard controllers 124, and/or the one or more common user interfaces 116 may be standalone components. It is noted herein, however, that the aircraft controller 102, the one or more offboard controllers 124, and/or the one or more common user interfaces 116 may be integrated within one or more common housings or chassis.

The aircraft controller 102 may be coupled (e.g., physically, electrically, and/or communicatively) to and configured to receive data from one or more sensors 118 such as one or more aircraft sensors 180 configured to detect atmospheric anomalies 216. The one or more aircraft sensors 180 may be configured to sense a particular condition(s) external or internal to the aircraft 100 and/or within the aircraft 100. The one or more aircraft sensors 180 may be configured to output data associated with particular sensed condition(s) to one or more components/systems onboard the aircraft 100. Generally, the one or more aircraft sensors 180 may include, but are not limited to, one or more inertial measurement units, one or more airspeed sensors, one or more radio altimeters, one or more flight dynamic sensors (e.g., sensors configured to sense pitch, bank, roll, heading, and/or yaw), one or more weather radars, one or more air temperature sensors, one or more surveillance sensors, one or more air pressure sensors, one or more engine sensors, and/or one or more optical sensors (e.g., one or more cameras configured to acquire images in an electromagnetic spectrum range including, but not limited to, the visible light spectrum range, the infrared spectrum range, the ultraviolet spectrum range, or any other spectrum range known in the art).

The aircraft controller 102 may be coupled (e.g., physically, electrically, and/or communicatively) to and configured to receive data from one or more navigational systems 120. The one or more navigational systems 120 may be coupled (e.g., physically, electrically, and/or communicatively) to and in communication with one or more GPS satellites 122, which may provide vehicular location data (e.g., aircraft location data) to one or more components/systems of the aircraft 100. For example, the one or more navigational systems 120 may be implemented as a global navigation satellite system (GNSS) device, and the one or more GPS satellites 122 may be implemented as GNSS satellites. The one or more navigational systems 120 may include a GPS receiver and a processor. For example, the one or more navigational systems 120 may receive or calculate location data from a sufficient number (e.g., at least four) of GPS satellites 122 in view of the aircraft 100 such that a GPS solution may be calculated.

It is noted herein the one or more aircraft sensors 180 may operate as a navigation device 120, being configured to sense any of various flight conditions or aircraft conditions typically used by aircraft and output navigation data (e.g., aircraft location data, aircraft orientation data, aircraft direction data, aircraft speed data, and/or aircraft acceleration data). For example, the various flight conditions or aircraft conditions may include altitude, aircraft location (e.g., relative to the earth), aircraft orientation (e.g., relative to the earth), aircraft speed, aircraft acceleration, aircraft trajectory, aircraft pitch, aircraft bank, aircraft roll, aircraft yaw, aircraft heading, air temperature, and/or air pressure. By way of another example, the one or more aircraft sensors 180 may provide aircraft location data and aircraft orientation data, respectively, to the one or more processors 104, 126.

The aircraft controller 102 of the aircraft 100 may be coupled (e.g., physically, electrically, and/or communicatively) to one or more offboard controllers 124.

The one or more offboard controllers 124 may include one or more processors 126, memory 128 configured to store one or more programs instructions 130 and/or one or more communication interfaces 132.

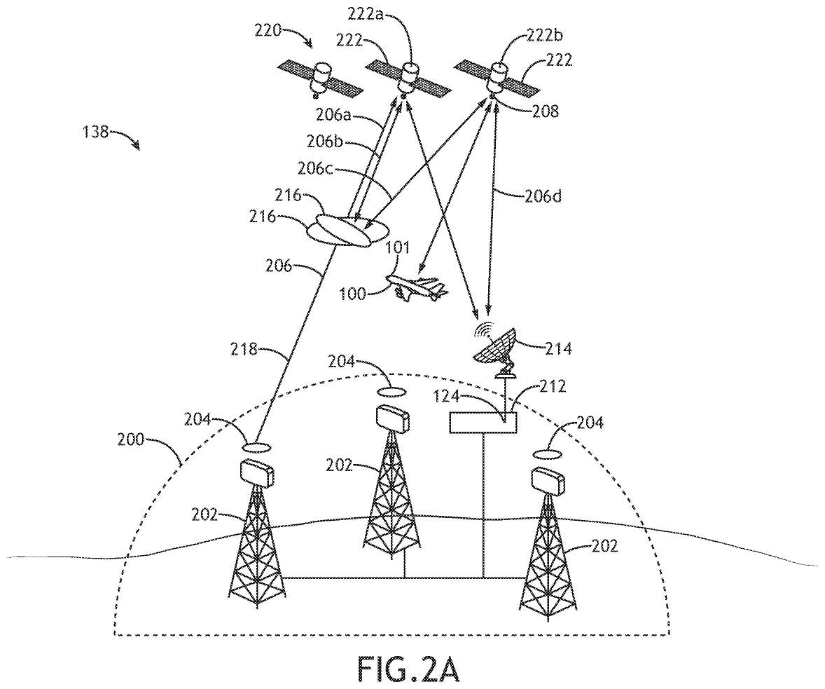

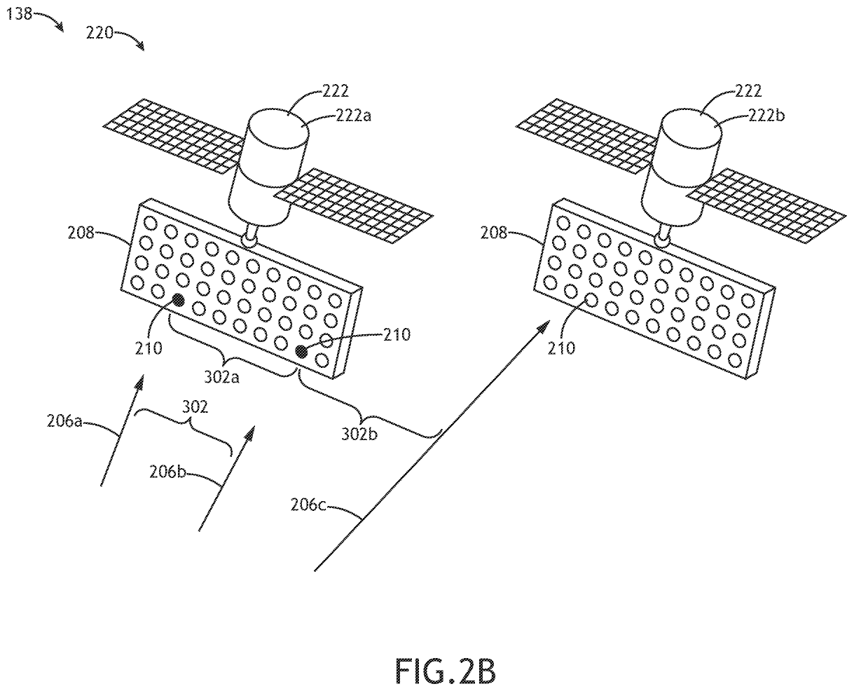

The aircraft controller 102 and/or the one or more offboard controllers 124 may be coupled (e.g., physically, electrically, and/or communicatively) to one or more satellites 134 (e.g., satellites such as satellites 222, 222a, 222b of FIGS. 2A and 2B). For example, the aircraft controller 102 and/or the one or more offboard controllers 124 may be coupled (e.g., physically, electrically, and/or communicatively) to one another via the one or more satellites 134. For instance, at least one component of the aircraft controller 102 may be configured to transmit data to and/or receive data from at least one component of the one or more offboard controllers 124, and vice versa. By way of another example, at least one component of the aircraft controller 102 may be configured to record event logs and may transmit the event logs to at least one component of the one or more offboard controllers 124, and vice versa. By way of another example, at least one component of the aircraft controller 102 may be configured to receive information and/or commands from the at least one component of the one or more offboard controllers 124, either in response to (or independent of) the transmitted event logs, and vice versa.

It is noted herein that the aircraft 100 and the components onboard the aircraft 100, the one or more offboard controllers 124, the one or more GPS satellites 122, and/or the one or more satellites 134 may be considered components of a system 138, for purposes of the present disclosure.

The one or more processors 104, 126 may include any one or more processing elements, micro-controllers, circuitry, field programmable gate array (FPGA) or other processing systems, and resident or external memory for storing data, executable code, and other information accessed or generated by the aircraft controller 102 and/or the one or more offboard controllers 124. In this sense, the one or more processors 104, 126 may include any microprocessor device configured to execute algorithms and/or program instructions. It is noted herein, however, that the one or more processors 104, 126 are not limited by the materials from which it is formed or the processing mechanisms employed therein and, as such, may be implemented via semiconductor(s) and/or transistors (e.g., using electronic integrated circuit (IC) components), and so forth. In general, the term “processor” may be broadly defined to encompass any device having one or more processing elements, which execute a set of program instructions from a non-transitory memory medium (e.g., the memory), where the set of program instructions is configured to cause the one or more processors to carry out any of one or more process steps.

The memory 106, 128 may include any storage medium known in the art suitable for storing the set of program instructions executable by the associated one or more processors. For example, the memory 106, 128 may include a non-transitory memory medium. For instance, the memory 106, 128 may include, but is not limited to, a read-only memory (ROM), a random access memory (RAM), a magnetic or optical memory device (e.g., disk), a magnetic tape, a solid state drive, flash memory (e.g., a secure digital (SD) memory card, a mini-SD memory card, and/or a micro-SD memory card), universal serial bus (USB) memory devices, and the like. The memory 106, 128 may be configured to provide display information to the display device (e.g., the one or more display devices 112). In addition, the memory 106, 128 may be configured to store user input information from a user input device of a user interface. The memory 106, 128 may be housed in a common controller housing with the one or more processors. The memory 106, 128 may, alternatively or in addition, be located remotely with respect to the spatial location of the processors and/or a controller. For instance, the one or more processors and/or the controller may access a remote memory (e.g., server), accessible through a network (e.g., internet, intranet, and the like).

The aircraft controller 102 and/or the one or more offboard controllers 124 may be configured to perform one or more process steps, as defined by the one or more sets of program instructions 108, 130. The one or more process steps may be performed iteratively, concurrently, and/or sequentially. The one or more sets of program instructions 108, 130 may be configured to operate via a control algorithm, a neural network (e.g., with states represented as nodes and hidden nodes and transitioning between them until an output is reached via branch metrics), a kernel-based classification method, a Support Vector Machine (SVM) approach, canonical-correlation analysis (CCA), factor analysis, flexible discriminant analysis (FDA), principal I component analysis (PCA), multidimensional scaling (MDS), principal component regression (PCR), projection pursuit, data mining, prediction-making, exploratory data analysis, supervised learning analysis, Boolean logic (e.g., resulting in an output of a complete truth or complete false value), fuzzy logic (e.g., resulting in an output of one or more partial truth values instead of a complete truth or complete false value), or the like. For example, in the case of a control algorithm, the one or more sets of program instructions 108, 130 may be configured to operate via proportional control, feedback control, feedforward control, integral control, proportional-derivative (PD) control, proportional-integral (PI) control, proportional-integral-derivative (PID) control, or the like.

The one or more communication interfaces 110, 132 may be operatively configured to communicate with one or more components of the aircraft controller 102 and/or the one or more offboard controllers 124. For example, the one or more communication interfaces 110, 134 may also be coupled (e.g., physically, electrically, and/or communicatively) with the one or more processors 104, 126 to facilitate data transfer between components of the one or more components of the aircraft controller 102 and/or the one or more offboard controllers 124 and the one or more processors 104, 126. For instance, the one or more communication interfaces 110, 134 may be configured to retrieve data from the one or more processors 104, 126, or other devices, transmit data for storage in the memory 106, 128, retrieve data from storage in the memory 106, 128, or the like. By way of another example, the aircraft controller 102 and/or the one or more offboard controllers 124 may be configured to receive and/or acquire data or information from other systems or tools by a transmission medium that may include wireline and/or wireless portions. By way of another example, the aircraft controller 102 and/or the one or more offboard controllers 124 may be configured to transmit data or information (e.g., the output of one or more procedures of the inventive concepts disclosed herein) to one or more systems or tools by a transmission medium that may include wireline and/or wireless portions (e.g., a transmitter, receiver, transceiver, physical connection interface, or any combination). In this regard, the transmission medium may serve as a data link between the aircraft controller 102 and/or the one or more offboard controllers 124 and the other subsystems (e.g., of the aircraft 100 and/or the system 138). In addition, the aircraft controller 102 and/or the one or more offboard controllers 124 may be configured to send data to external systems via a transmission medium (e.g., network connection).

The one or more display devices 112 may include any display device known in the art. For example, the display devices 112 may include, but are not limited to, one or more head-down displays (HDDs), one or more HUDs, one or more multi-function displays (MFDs), or the like. For instance, the display devices 112 may include, but are not limited to, a liquid crystal display (LCD), a light-emitting diode (LED) based display, an organic light-emitting diode (OLED) based display, an electroluminescent display (ELD), an electronic paper (E-ink) display, a plasma display panel (PDP), a display light processing (DLP) display, or the like. Those skilled in the art should recognize that a variety of display devices may be suitable for implementation in the present invention and the particular choice of display device may depend on a variety of factors, including, but not limited to, form factor, cost, and the like. In a general sense, any display device capable of integration with the user input device (e.g., touchscreen, bezel mounted interface, keyboard, mouse, trackpad, and the like) is suitable for implementation in the present invention.

The one or more user input devices 114 may include any user input device known in the art. For example, the user input device 114 may include, but is not limited to, a keyboard, a keypad, a touchscreen, a lever, a knob, a scroll wheel, a track ball, a switch, a dial, a sliding bar, a scroll bar, a slide, a handle, a touch pad, a paddle, a steering wheel, a joystick, a bezel input device, or the like. In the case of a touchscreen interface, those skilled in the art should recognize that a large number of touchscreen interfaces may be suitable for implementation in the present invention. For instance, the display device may be integrated with a touchscreen interface, such as, but not limited to, a capacitive touchscreen, a resistive touchscreen, a surface acoustic based touchscreen, an infrared based touchscreen, or the like. In a general sense, any touchscreen interface capable of integration with the display portion of a display device is suitable for implementation in the present invention. In another embodiment, the user input device may include, but is not limited to, a bezel mounted interface.

FIG. 2A illustrates a system 138 including a network 200 of ground-based nodes 202 and a constellation 220 of satellites 222, in accordance with one or more embodiments of the present disclosure.

FIG. 2B illustrates a set of refracted beams 206a, 206b, 206c, 206d dispersed across one or more satellites 222a, 222b, in accordance with one or more embodiments of the present disclosure.

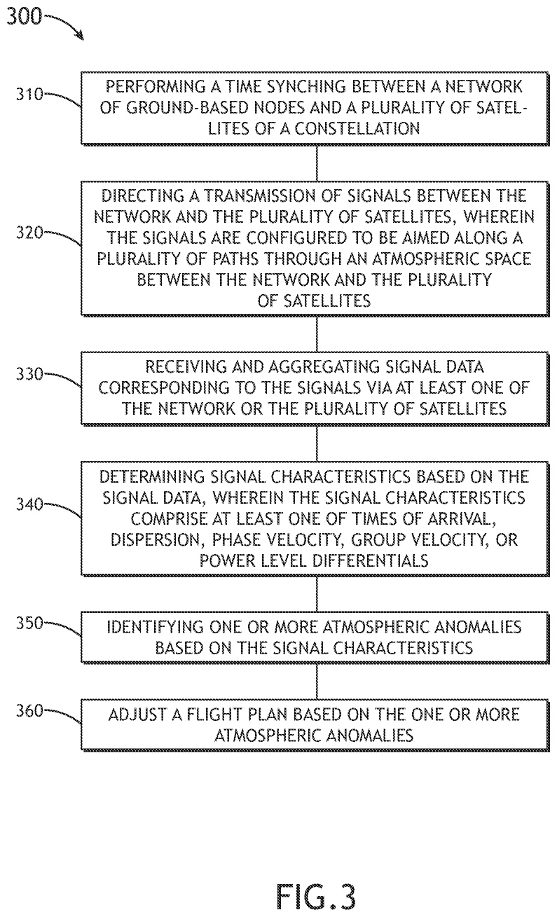

FIG. 3 illustrates a flow diagram illustrating steps performed in a method 300 for atmospheric anomaly detection, in accordance with one or more embodiments of the present disclosure. The method 300 may be implemented on one or more controllers. For example, the controllers may include offboard controllers 124 (e.g., satellite controllers, ground-based node controllers, controllers on a cloud network. For example, the controllers may include onboard controllers 102 of an aircraft 100.

At step 310, a time synching may be performed between a network 200 of ground-based nodes 202 and a plurality of satellites 222 of a constellation 220.

Time syncing between the network 200 and the satellites 222 may be accomplished through various methodologies. For example, satellite-based timekeeping methods may include the reception of atomic clock signals from satellites 222. Furthermore, two-way time transfer methods may be employed, wherein a signal is sent from the ground-based nodes 202 to the satellites 222 and back again, with the travel time being measured to adjust for any time discrepancies.

At step 320, a transmission of signals 206 may be directed between nodes of the network 200 and the plurality of satellites 222, in either direction. For example, the signal 206 may travel in either direction, such that the network 200 and/or the plurality of satellites 222 are the transmitter and/or receiver of refracted signals. The signals 206 may be configured to be aimed along a plurality of paths 218 through an atmospheric space 230 between the network 200 and the plurality of satellites 222, such as being sent by multiple nodes, where each node transmits to multiple other nodes across the atmosphere to increase coverage.

The configuration of the signals 206 for transmission may involve the utilization of beamforming techniques (e.g., electronically scanned arrays (ESAs)) to focus the signal energy along specific paths 218. For example, adaptive algorithms may be implemented to adjust the signal paths 218 in real-time to account for satellite 222 positions in orbit. Scanning patterns may be used. For instance, a plurality of satellites 222 may be used (of any number of constellations 220), which may result in large amount of diverse paths 218 for increasing the resolution. In this way, more of the atmosphere may be scanned, especially with large numbers of satellites 222.

At step 330, signal data corresponding to the signals 206 may be received and aggregated via at least one of the network 200 or the plurality of satellites 222. For example,

Upon receiving the signals 206 as signal data (e.g., bytes of information), the network 200 or the satellites 222 may employ various aggregation techniques. The signal data may be analyzed individually and/or in aggregate. For example, two signal beams 206b and 206c received by spaced out satellites 222a, and 222b may be aggregated to a common controller 124 and then compared to determine that they originated from a common signal 206 and that a refraction must have occurred along the path 218. The aggregation process may also involve time-stamping the received signals 206a, 206b to preserve the temporal information. The common controller 124 may include an antenna 214 of a communication interface 212.

At step 340, signal characteristics may be determined based on the signal data. The signal characteristics may include at least one of times of arrival, dispersion, phase velocity, group velocity, or power level differentials. For example, the signal characteristics may include at least three of times of arrival, dispersion, phase velocity, group velocity, or power level differentials. For example, the signal characteristics may include times of arrival, dispersion, phase velocity, group velocity, and power level differentials.

Signal characteristics may be determined using a variety of analytical techniques. For instance, times of arrival may be measured using timestamps attached to signal data upon reception. Dispersion of signals may be analyzed by comparing the spread of signal frequencies over time. Phase and group velocities may be calculated by measuring the phase and amplitude variations of the signal data over multiple receiving points. Power level differentials may be ascertained by comparing received signal strengths across a spatial distribution of the network 200 or satellites 222. These signal characteristics may be determined for each of the paths 218 (and correspond to respective paths 218 and signals 206 of those paths) and may be used to construct a detailed profile of the atmospheric space 230. For example, paths 218 associated with an amount of refraction above a detection threshold (e.g., more than 0.001 degrees of refraction, being refracted more than 200 meters compare to a path 218 aimed from) may correspond to an identified atmospheric anomaly 216.

At step 350, one or more atmospheric anomalies 216 may be identified based on the signal characteristics.

Identification of atmospheric anomalies 216 may involve the use of detection algorithms that analyze the signal characteristics to pinpoint irregularities in the atmosphere. For example, a sudden change in phase velocity may indicate the presence of a jet stream, while a variation in power levels could suggest atmospheric absorption or scattering phenomena. The detection algorithms may compare current signal characteristics against historical data or detection thresholds to determine the presence of an anomaly 216. Furthermore, machine learning models may be employed to recognize patterns within the signal characteristics that are indicative of specific types of atmospheric anomalies 216. Additionally, machine learning models may be used to anticipate probable geospatial directional movement of the atmospheric anomalies.

At step 360, a flight plan may be adjusted based on the one or more atmospheric anomalies 216.

Adjustments to a flight plan based on identified atmospheric anomalies 216 may be performed using flight management systems 120, which may incorporate real-time data inputs. For instance, an algorithm may suggest alternative routing to avoid regions where significant signal dispersion has been detected, which may correlate with turbulent conditions. Corrections to the flight path may be calculated to minimize the impact of headwinds or to exploit favorable tailwinds identified by analyzing power level differentials. These adjustments may be communicated to the autopilot system of an aircraft for automatic execution or may be relayed to pilots for manual implementation.

Referring to FIG. 2B, the plurality of satellites 222 may include at least two separated antenna elements 210 spanning a distance 302. For example, the antenna elements 210 may be elements of one or more antenna sub-systems 208 (e.g., array of antenna elements, a panel, an electronically scanned array (ESA) panel, and/or the like). A portion of the signal data corresponding to a common signal 206 may be configured to be received via the least two separated antenna elements 210 and corresponding to at least two spatially distinct refracted beams 206a, 206b, 206c of the common signal 206. The signal characteristics may include the distance 302 (e.g., the distance 302 may be stored as a signal characteristic and used to identify atmospheric anomalies 216 based on being over a threshold distance).

For instance, the separated antenna elements 210 may be positioned at predetermined distances 302, such as intra-satellite distances 302a of antenna elements 210 on the same/single satellite 222. The configuration of the antenna elements 210 may allow for the reception of signals 206 that have traversed different paths 218 through the atmospheric space 230. For example, a greater distance 302 may allow for the detection of finer variations in the signal characteristics, such as small changes in phase or amplitude that may indicate atmospheric disturbances. The received signal data from the distinct refracted beams 206a, 206b, 206c may be processed to determine the angle of arrival, which, when combined with the known distance 302, may provide spatial information regarding the signal's path 218 and the atmospheric conditions encountered. The ephemeris and orbit mechanics of the satellites 222 may be known and accounted for in the signal processing and sensing of the atmospheric anomalies 216.

For instance, when the antenna elements 210 are at opposite ends of the satellite 222a, the distance 302 may be maximized for a singular satellite 222, or the antenna elements 210 may be arrayed in a particular pattern to facilitate a specific beamforming strategy. The positions of the antenna elements 210 may be simply the positions where the signals 206a, 206b, 206c are received.

In embodiments, any sized antenna sub-systems 208 and corresponding length of distance 302 may be used. For instance, relatively large distance 302 may be used, such as more than 10 feet, more than 15 feet, and/or more than 25 feet may be used. A larger distance 302 of an array 208 may markedly improve capture of differentials in phase and time of arrival in ground RF beacons 202.

The distance 302 may be based on an evaluation of a spatial configuration distance 302b between separate satellites 222a, 222b.

The spatial configuration distance 302b between separate satellites 222 (e.g., satellites 222a, 222b) may be determined by the relative positions of the satellites 222 within their respective orbits. This configuration may be dynamic, as the satellites 222 move along their orbital paths. The determination of the spatial configuration 302b may simply be received as known information, such as being reported via satellite operators. The determination of the spatial configuration 302b may involve orbital mechanics calculations and predictive modeling to determine/calculate a known (and/or desired) separation distance 302b over time.

The signal characteristics may include scintillation determined based on the distance 302.

Scintillation as a signal characteristic may be assessed by analyzing fluctuations in the amplitude and phase of the received signals over the distance 302. The variations in signal intensity and phase consistency may be indicative of the effects of atmospheric turbulence on the signal path 218. By comparing the signal data received at the separated antenna elements 210 or across the separate satellites 222a, 222b, the degree of scintillation can be quantified. This quantification may involve statistical analysis of the signal variations over time and may be used to infer the level of atmospheric turbulence along the signal path 218. Signal processing may be performed at any stage of one or more processing steps of the system 138, including the baseband stage (e.g., the stage where the signal has been demodulated to its original frequency range), the intermediate frequency stage (e.g., a stage where the signal is processed at a frequency between the original baseband and the radio frequency), or the radio frequency stage (e.g., the stage where the signal is at its original high frequency as received by the antenna).

The one or more atmospheric anomalies 216 may include a size and a depth, which may be determined using any method.

The determination of the size and depth of atmospheric anomalies 216 may involve the use of signal processing techniques to analyze the spatial and temporal aspects of the signal characteristics. For instance, triangulation of multiple paths 218 may be used to triangulate a three-dimensional coordinate (e.g., latitude, longitude, and altitude) representation of the atmospheric anomaly 216. For instance, tomographic reconstruction methods may be applied to signal data collected from multiple paths 218 to create a three-dimensional representation of the atmospheric anomaly 216. The depth of the anomaly may be inferred from the degree of signal dispersion or delay, while the size may be estimated from the spatial extent of the affected signal characteristics across the network 200 or satellite constellation 220.

The network 200 may be further configured for weather detection.

For example, a radar-based weather detection network of ground based nodes 202 may be used for dual-purpose detection of both weather (e.g., cloud, particles detection based on radar reflections, as well as atmospheric anomalies 216 detection (e.g., radar-based refractions). This may save costs. Data from the transmitters 204 and/or receivers 204 (e.g., radar transmitters and/or receivers) of the nodes 202 may be combined with the signal characteristics derived from the signals 206 to enhance the detection and analysis of atmospheric conditions. The network 200 may also interface with external weather data sources to augment the information available for weather prediction and analysis.

The one or more atmospheric anomalies 216 may be aggregated to extract and generate four-dimensional (4D) atmospheric anomaly data.

The aggregation of atmospheric anomalies 216 to generate 4D data may involve the collection and synthesis of signal characteristics over time and across multiple spatial dimensions. This process may include the correlation of data from various signal paths 218 and the application of data fusion techniques to integrate disparate data sources. The resulting 4D atmospheric anomaly data may provide a comprehensive view of the evolution of atmospheric conditions, including the movement and changes in the anomalies over time.

The signals 206 may span multiple radio frequency (RF) bands.

Spanning multiple RF bands may allow for a more robust analysis of the atmospheric space 230, as different frequencies may interact with the atmosphere in unique ways. For example, lower frequencies may be less affected by atmospheric moisture, while higher frequencies may provide greater resolution for detecting small-scale atmospheric features. The use of a wide range of frequencies may also provide redundancy in the data collection process, ensuring that atmospheric conditions can be monitored under a variety of scenarios and signal propagation conditions.

Regions and associated atmospheric densities of the regions may be identified based on the signal characteristics. The flight plan may be adjusted to fly through a particular region based on a respective atmospheric density of the region. For example, the flight plan may be adjusted to fly through a particular region based on the respective atmospheric density of the region being higher (e.g., relatively higher than an alternative atmospheric density). In this regard, the aircraft 100 may be directed to fly through higher density regions for improved performance.

The identification of regions with varying atmospheric densities may be achieved through the analysis of signal characteristics such as refraction angles, signal delay, and scintillation patterns. These characteristics may be indicative of the density and composition of the atmosphere through which the signals have passed. Flight plans may be adjusted to take advantage of regions with higher atmospheric density, which may offer less resistance and potentially more favorable flight conditions. The adjustment process may involve the calculation of alternative flight paths and the assessment of potential benefits, such as reduced fuel consumption or improved flight times, while maintaining safety and regulatory compliance.

The adjusting the flight plan may be configured to be communicated via a communication interface 110 positioned in an electromagnetically transparent nose radome 101 (e.g., a nosecone 101) of the aircraft 100. The communication interface 110 may include an optical communication interface (e.g., receiver configured to receive optical communications such as laser communication light communicating using optical laser communication protocols) or an RF communication interface (e.g., receiver/antenna configured to receive radio frequency communications such as laser communication protocols).

In embodiments, any component, method, or the like, may be used for communicating data, such as flight plan changes to the aircraft 100. For example, U.S. patent application Ser. No. 18/541,615, filed on Dec. 15, 2023, which is herein incorporated by reference in its entirety may disclose positions of antennas, arrangements of components, and the like. For example, embodiments herein may include any communication interface 110, which may be (and/or) include any transceiver, receiver, antenna, component, arrangement, position (of antenna), and/or the like from the U.S. patent application Ser. No. 18/541,615. For instance, communication interface 110 may include an antenna positioned inside the aircraft 100 (e.g., inside a fuselage, nosecone, and/or the like). For example, positions of components (e.g., antennas, receivers) as shown in reference to FIGS. 3, 4, and 5 of U.S. patent application Ser. No. 18/541,615, filed on Dec. 15, 2023, which are herein incorporated by reference in their entirety.

For example, the system 138 may be configured to (and the method 300 may include steps for): directing a transmission of signal 206 to satellites 222 from ground-based nodes 202; receiving signal data back on ground (e.g., at nodes 202); processing signal data (e.g., determining the signal characteristics and/or identifying atmospheric anomalies 216 on the ground); and transmitting the signal characteristics and/or atmospheric anomalies 216 to the aircraft communication interface 110. For example, the transmission of the signal characteristics and/or atmospheric anomalies 216 to the aircraft communication interface 110 may be performed via a 5G air to ground link in accordance with embodiments of U.S. patent application Ser. No. 18/541,615, filed on Dec. 15, 2023, which is herein incorporated by reference in its entirety. It is contemplated that U.S. patent application Ser. No. 18/541,615 embodiments may enable relatively low-cost and reliable implementations for communicating to aircraft 100, such as embodiments that use internal antennas rather than external antennas with holes in the fuselage of the aircraft 100.

For instance, a communication interface 110 may include a receiver (e.g., antenna) for receiving data in a nosecone of the aircraft 100. For example, such data may include data of the atmospheric anomalies 216, such as their location, and/or navigation information such as changes to make to flight paths.

In some embodiments, the sensors 118 include sensors (e.g., aircraft sensors 180 such as accelerometers, gyrometers, LIDAR, and/or the like). These sensors 118 may be configured to be used by themselves for identifying atmospheric anomalies 216, and/or to contribute data to be combined (i.e., fused) with other data for the identifying of atmospheric anomalies 216 in step 350. For example, the method 300 may include an optional step of receiving aircraft data of aircraft sensors 180 (e.g., a type of sensor 118), such as being received by the ground nodes 202. The identifying atmospheric anomalies 216 of step 350 may further be based on such aircraft data of sensors 180. For example, acceleration above an acceleration threshold (e.g., above 0.1 m/s², or the like) may be sent (along with aircraft position data) to the ground nodes 202. For instance, the common controller 124 (e.g., networked controller, cloud server computer, shared controller) may be configured to receive aircraft data from one or more sensors 118 of one or more aircraft 100, in combination with signal data (and/or signal characteristics) to identify the atmospheric anomalies 216. For example, the controller 102, 124 (e.g., a machine learning model stored on memory 106, 128) may be configured to (e.g., trained to, programmed to receive as variable inputs) receive aircraft data (e.g., accelerometer data) and signal characteristics to identify (e.g., output) the atmospheric anomalies 216. In this regard, the identifications may be more accurate. For instance, the aircraft data may aid in real-time atmospheric anomaly detection to alert other aircraft.

At an optional step, the transmission of atmospheric anomalies 216 to an airplane 100 may be conducted through various communication protocols and systems. The network 200 or satellites 222 may be equipped with transmitters capable of sending data to the communication interfaces 110 aboard the airplane 100. For example, the transmission may occur over dedicated aviation communication frequencies or via satellite communication channels. This may involve the encapsulation of the data within standard communication frames and the use of error-checking codes to ensure data integrity during transmission. Upon receipt, the airplane's onboard systems (e.g., controller 102) may process the received data to update the flight management system 120 with the latest information. The data may be displayed to the pilots on the user interfaces 116 such as one or more displays 112. The data may be used by the airplane's autopilot system to make real-time adjustments to the flight path. The system 138 may also transmit an alert (e.g., audio and/or visual alert) to the pilots to alert the pilots of the presence of atmospheric anomalies 216 that may require intervention (e.g., manual, automated or FAA directed intervention) or changes to the flight plan.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. A method for atmospheric anomaly detection, the method comprising:
performing a time synching between a network of ground-based nodes and a plurality of satellites of a constellation;
directing a transmission of signals between the network and the plurality of satellites, wherein the signals are configured to be aimed along a plurality of paths through an atmospheric space between the network and the plurality of satellites;
receiving and aggregating signal data corresponding to the signals via at least one of the network or the plurality of satellites;
determining signal characteristics based on the signal data, wherein the signal characteristics comprise at least one of times of arrival, dispersion, phase velocity, group velocity, or power level differentials;
identifying one or more atmospheric anomalies based on the signal characteristics; and
adjusting a flight plan of an aircraft based on the one or more atmospheric anomalies.

2. The method of claim 1, wherein the plurality of satellites comprise at least two separated antenna elements spanning a distance,
wherein a portion of the signal data corresponding to a common signal is configured to be received via the least two separated antenna elements and corresponding to at least two spatially distinct refracted beams of the common signal,
wherein the signal characteristics comprises the distance.

3. The method of claim 2, wherein the distance is based on an evaluation of a spatial configuration of the at least two separated antenna elements arrayed on one or more antenna sub-systems of a singular satellite.

4. The method of claim 2, wherein the distance is based on an evaluation of a spatial configuration between separate satellites.

5. The method of claim 2, wherein the signal characteristics comprise scintillation determined based on the distance.

6. The method of claim 1, wherein the one or more atmospheric anomalies comprise a size and a depth.

7. The method of claim 1, further comprising aggregating the one or more atmospheric anomalies to extract and generate four-dimensional (4D) atmospheric anomaly data.

8. The method of claim 1, wherein the signals span multiple radio frequency (RF) bands.

9. The method of claim 1, further comprising identifying regions and associated atmospheric densities of the regions based on the signal characteristics, and wherein the adjusting the flight plan includes adjusting the flight plan to fly through a particular region based on a respective atmospheric density of the particular region being higher than an alternative atmospheric density of an alternative region.

10. The method of claim 9, wherein the adjusting the flight plan is configured to be communicated via a communication interface positioned in an electromagnetically transparent nose radome of an aircraft, wherein the communication interface comprises at least one of:
an optical communication interface; or
an RF communication interface.

11. A system for atmospheric anomaly detection, the system comprising:
a network of ground-based nodes;
a plurality of satellites of a constellation, wherein the network and the plurality of satellites are configured to perform a time synching; and
one or more controllers including one or more processors configured to execute a set of program instructions stored in a memory, the set of program instructions configured to cause the one or more processors to:
perform a time synching between the network of ground-based nodes and the plurality of satellites of the constellation;
direct a transmission of signals between the network and the plurality of satellites, wherein the signals are configured to be aimed along a plurality of paths through an atmospheric space between the network and the plurality of satellites;
receive and aggregate signal data corresponding to the signals via at least one of the network or the plurality of satellites;
determine signal characteristics based on the signal data, wherein the signal characteristics comprise at least one of times of arrival, dispersion, phase velocity, group velocity, or power level differentials;
identify one or more atmospheric anomalies based on the signal characteristics; and
adjust a flight plan based on the one or more atmospheric anomalies.

12. The system of claim 11, wherein the plurality of satellites comprise at least two separated antenna elements spanning a distance, wherein a portion of the signal data corresponding to a common signal is configured to be received via the at least two separated antenna elements and corresponding to at least two spatially distinct refracted beams of the common signal, wherein the signal characteristics comprises the distance.

13. The system of claim 12, wherein the distance is based on an evaluation of a spatial configuration of the at least two separated antenna elements arrayed on one or more antenna sub-systems of a singular satellite.

14. The system of claim 12, wherein the distance is based on an evaluation of a spatial configuration between separate satellites.

15. The system of claim 12, wherein the signal characteristics comprise scintillation determined based on the distance.

16. The system of claim 11, wherein the set of program instructions are further configured to cause the one or more processors to aggregate the one or more atmospheric anomalies to extract and generate four-dimensional (4D) atmospheric anomaly data.

17. The system of claim 11, wherein the signals span multiple radio frequency (RF) bands.

18. The system of claim 11, wherein the set of program instructions are further configured to cause the one or more processors to identify regions and associated atmospheric densities of the regions based on the signal characteristics, and wherein the adjusting the flight plan includes adjusting the flight plan to fly through a particular region based on a respective atmospheric density of the particular region being higher than an alternative atmospheric density of an alternative region.

19. The system of claim 18, wherein the adjusting the flight plan is configured to be communicated via a communication interface positioned in an electromagnetically transparent nose radome of an aircraft, wherein the communication interface comprises at least one of:
an optical communication interface; or
an RF communication interface.

20. The system of claim 18, wherein the aircraft comprises aircraft sensors and wherein the controller is further configured to receive aircraft data from the aircraft sensors, and wherein the identifying the one or more atmospheric anomalies is further based on the aircraft data.
